(19) United States
(12) Patent Application Publication
(10) Pub. No.: US 2008/0228581 A1
(43) Pub. Date: Sep. 18, 2008

(54) Method and System for a Natural Transition Between Advertisements Associated with Rich Media Content

(76) Inventors: Tadashi Yonezaki, Newton, MA (US); Steven Lee, Stamford, CT (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/047,169

(22) Filed: Mar. 12, 2008

Related U.S. Application Data
(60) Provisional application No. 60/906,712, filed on Mar. 13, 2007.

(51) Int. Cl. G06Q 30/00

(52) U.S. Cl. 705/14

(57) ABSTRACT

A method includes receiving a plurality of a plurality of candidate segmentation points associated with a portion of rich media content, selecting a subset of the candidate segmentation points that meet one or more segmentation constraints, where the selected subset of segmentation points define a plurality of temporal segments of the rich media content, and providing the selected subset of segmentation points for association of a different one of a plurality of advertisements with each of the temporal segments.

### REFERENCE TO RELATED APPLICATIONS

This application claims priority from U.S. Provisional Patent Application No. 60/906,712, entitled “Method to Natural Transition of Advertisement”, filed Mar. 13, 2007, the disclosure of which is incorporated herein by reference in its entirety.

### BACKGROUND

The disclosed embodiments relate generally to digital media and more specifically to displaying advertisements with rich media content.

A user can perform a text search for content using a search engine. When the search is matched to text content, the results are displayed on a web page. The search results are typically static. For example, if a user was searching for certain web pages, the web pages and URLs would be listed on the page and do not change.

Advertisements related to the content may then be placed in certain sections of the page. Because the content on the page is static, the advertisements are matched to the content once. The placement of the advertisements on the page may be optimized, such as placing the advertisement at the beginning of the results. However, because the content on the web page is static, there is no need to match the advertisements to content that changes over time. It is assumed that once the search is finished, the content remains the same.

With the advent of video and similar rich media content, different features may be provided in the content. For example, content may include audio, moving objects, etc. Additionally, there may be topical, scene, and/or speaker changes within a single piece of content. Accordingly, it may be more desirable to display multiple advertisements with a single piece of rich media content.

However, changing, or “rotating” advertisements periodically during playback of a piece of content can distract the viewer. For example, changing advertisements during a particular scene may distract a viewer if the advertisement is not related to the scene's subject matter. Moreover, if an advertisement changes periodically, the viewer may begin to ignore advertisements because humans tend to ignore periodic changes.

### SUMMARY

An advertisement may be matched to subject matter in a portion of rich media content. For example, it may be determined by analysis of the audio and/or visual components of the rich media content, and/or data associated with the content, that the content's subject matter matches or correlates with an advertisement. When there is a change in the subject matter of the content, such as, for example, a change in topic, speaker, or video scene, another advertisement is matched to the new subject matter of the content. As a result, the rich media content is temporally segmented, with each segment matched to a particular advertisement.

If the beginning of a segment does not correspond temporally with natural transitions within the content, the user may be distracted by the change of advertisement. A natural transition can be, for example, a visual scene change, wipe, change of speaker, transition of subtitles, or any other major or minor change of video or audio features. To avoid this distraction, the temporal positions of natural transitions of a piece of rich media content are identified. If the natural transition satisfies certain constraints, then a new advertisement is rotated in at that transition. One example of such a constraint is that a new advertisement cannot be shown until a certain amount of time has passed.

A further understanding of the nature and the advantages of the disclosed embodiments may be realized by reference of the remaining portions of the specification and the attached drawings.

### BRIEF DESCRIPTION OF THE DRAWINGS

FIG. 1 is a simplified illustration of an exemplary system for serving advertisements with rich media content.

FIG. 2 is a more detailed illustration of the system of FIG. 1, expanding on the engine component.

FIGS. 3A and 3B illustrate the operation of one function of an alignment module of the engine component of FIG. 2.

FIG. 4 is a flow chart illustrating the operation of a second function of the alignment module.

FIG. 5 is an example of the operation of the second function of the alignment module.

### DETAILED DESCRIPTION

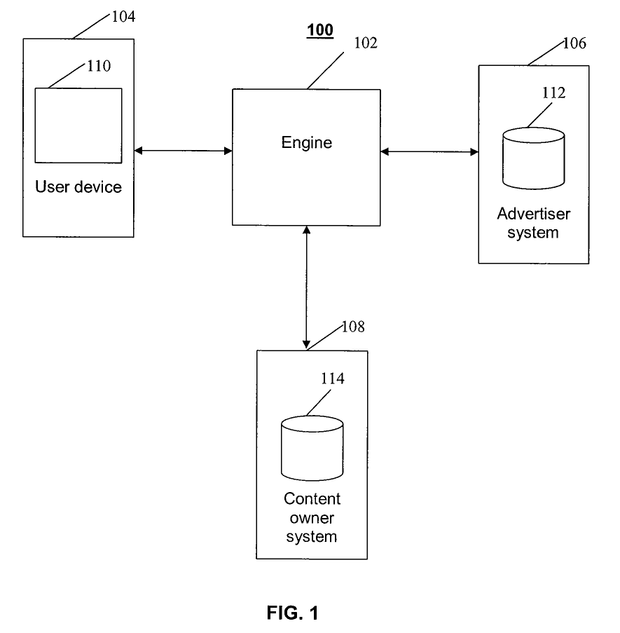

FIG. 1 is a simplified illustration of an exemplary system 100 for serving advertisements with rich media content. Such systems are described more fully in U.S. patent application Ser. No. 11/594,707, entitled “Techniques for Rending Advertisements with Rich Media,” (“the '707 application) the disclosure of which is incorporated herein by reference in its entirety. The system includes an engine 102, user device 104, advertiser system 106, and content owner system 108.

Engine 102 may be any device/system that provides serving of advertisements to user device 104. In one embodiment, engine 102 correlates advertisements to subject matter associated with rich media content. Accordingly, an advertisement that correlates to the subject matter associated with the portion of rich media content may be served such that it can be rendered on user device 104 relative to the portion of rich media content. Different methods may be used to correlate or match advertisements to portions of the rich media content.

Advertiser system 106 provides advertisements from advertisement database 112. Advertisements may include any information and have any of a variety of formats. For example, advertisements may include information about the advertiser, such as the advertiser's products, services, etc. Advertisements include but are not limited to elements possessing text, graphics, audio, video, animation, special effects, and/or user interactivity features, uniform resource locators (URLs), presentations, targeted content categories, etc. In some applications, audio-only or image-only advertisements may be used.

Advertisements may include non-paid recommendations to other links/content within the site or to other sites. The advertisement may also be data from the publisher (other links and content from them) or data from a servicer of engine 102 (e.g., from its own data sources (such as from crawling the web)), or some other third-party data sources. The advertisement may also include coupons, maps, ticket purchase information, or any other information.

An advertisement may be broken into ad units. An ad unit may be a subset of a larger advertisement. For example, an advertiser may provide a matrix of ad units. Each ad unit may be associated with a concept. The ad units may be selected individually to form an advertisement. Thus, advertiser system 106 is not restricted to just serving an entire advertisement. Rather, the most relevant pieces of the advertisement may be selected from the matrix of ad units.

The ad units may perform different functions. Instead of just relaying information, different actions may be facilitated. For example, an ad unit may include a widget that collects user information, such as an email address or phone number. The advertiser may then contact the user later with additional information about its products/services.

An ad unit may also include a widget that stores a history of ads. The user may use this widget to rewind to any of the previously shown ads, fast forward and see ads yet to be shown, show a screen containing thumbnails of a certain number of ads such that a user can choose which one to play, etc.

An ad unit may include a widget that allows users to send the ad to others. This facilitates viral spreading of the ad. For example, the user may use an address book to select users to forward the ad to. Further, an ad unit, when it is replaced by another ad unit, may be minimized into a small widget that allows the user to retrieve the ad, send it to others, etc.

An ad unit may also be created in various ways. An ad unit may be created by applying a template to existing static ad units to convert them to video that may serve as pre-, mid-, or post-roll. An ad unit may be created by augmenting a static ad unit with an advertiser-specified message dependent on context and keywords.

Advertisements will be described in the disclosure, but it will be understood that an advertisement may be any of the ad units as described above. Also, the advertisement may be a single ad unit or any number of a combination of ad units.

Advertiser system 106 provides advertisements to engine 102. Engine 102 may then determine when to serve advertisements from advertisement content database 112 to user device 104. This process will be described in more detail below.

Content owner system 108 provides content stored in content database 114 to engine 102 and user device 104. The content includes rich media content. Rich media content may include but is not limited to content that possesses elements of audio, video, animation, special effects, and/or user interactivity features. For example, the rich media content may be a streaming video, a stock ticker that continually updates, a pre-recorded web cast, a movie, Flash™, animation, slide show, or other presentation. The rich media content may be provided through a web page or through any other methods, such as streaming video, streaming audio, pod casts, etc.

Rich media content may be digital media that is dynamic. This may be different from non-rich media content, which may include standard images, text links, and search engine advertising. The non-rich media may be static over time while rich media content may change over time. The rich media content may also include user interaction but does not have to.

User device 104 may be any device. For example, user device 104 may be a desktop computer, laptop computer, personal digital assistant (PDA), cellular telephone, set-top box and display device, digital music player, etc. User device 104 includes a display 110 and a speaker (not shown) that may be used to render content and/or advertisements in video and/or audio form.

Advertisements may be served from engine 102 to user device 104. User device 104 can then render the advertisements. Rendering may include the displaying, playing, etc. of rich media content. For example, video and audio may be played where video is displayed on display 110 and audio is played through a speaker (not shown). Also, text may be displayed on display 110. Thus, rendering may be any output of rich media content on user device 102.

The advertisements can be correlated to a portion of the rich media content. The advertisement can then be displayed relative to that portion in time. For example, the advertisement may be displayed in serial, parallel, or be injected into the rich media content.

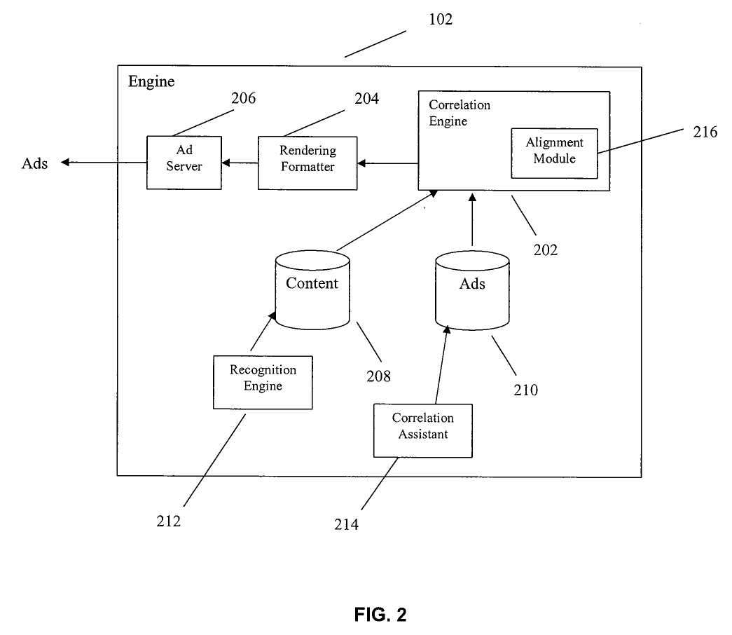

FIG. 2 illustrates system 100 in greater detail, showing the constituent components of engine 102. As shown, engine 102 can include a correlation engine 202 (including an alignment module 216), a rendering formatter 204, an ad server 206, a content database 208, an ad database 210, a recognition engine 212, and a correlation assistant 214. Engine 102 can interact with an advertiser web site 218.

Correlation engine 202 receives advertisements and associated ad information from ad database 210 and rich media content and associated content information from content database 208. The advertisements and content may have been previously received from one or more content owners (via one or more content owner systems 108) and one or more advertisers (via one or more advertiser systems 106).

Correlation engine 202 is configured to determine an advertisement that correlates to subject matter associated with a portion, or time segment, of the rich media content. For example, at a certain time, period of time, or multiple instances of times, an advertisement may be correlated to subject matter in the content. For example, an advertisement may be associated with a keyword. When that keyword is used in the content, correlation engine 202 correlates the advertisement to a portion or time segment of content in which the keyword is used.

Recognition engine 212 receives rich media content, for example from content owner system 108, and can use various techniques to recognize the content, or derive information about the content. These techniques can be applied to the audio component (if any) of the content, to the visual component (if any) of the content, and/or to textual data (if any) associated with the content. The audio component of the content can be analyzed using speech recognition, to derive a text transcript of the audio component. From this text transcript, keywords can be determined. In addition, the text transcript can be analyzed for subject matter or topic, and transitions from topic to topic can be identified. The text transcript may be analyzed using tools such as a natural language processing engine and/or an indexing engine.

The audio component of the rich media content can also be analyzed to detect or identify music on music portions, or sound effects on sound effects portions, etc. Further, the audio component can be analyzed to identity the speaker in speech portions, and/or to identify transitions from speaker to speaker, alone or in combination with analysis of the text transcript. Gaps or pauses in speech, in music, or in any other aspect of the audio component can also be detected and identified as such.

Various techniques can be applied to the visual component of the rich media content. For example, optical character recognition (OCR) can be used to extract text. The identity of persons present in a scene can be determined by facial recognition and the identity of objects can be determined by object matching techniques. Any of the many available video or visual analytics techniques can be used to extract other information about the visual component, including the content or subject of a scene, transitions from scene to scene, or other change in video feature such as a wipe, fade, transition of subtitles, etc.

Recognition engine 212 can also analyze textual data associated with the rich media content. These data can include meta-data descriptive of the content, and/or a text transcript (provided by the content owner system 108 or by a third party). As with the text transcript produced by analysis of speech in the audio component of the rich media content, the associated textual data can be analyzed by tools such as a natural language processing engine and/or an indexing engine. Recognition engine 212 outputs information extracted from analysis of the rich media content and/or associated textual data, along with a time stamp or other indication of time, or time segment, in the rich media content with which the extracted information is associated. Each of these time indications, i.e. positions in the timeline of the rich media content, is a potential segmentation point for the content, i.e. a point at which an advertisement may start, or rotate in place of a prior advertisement. As described above, these potential segmentation points can represent natural transitions in the content, such as, for example, video scene changes, topic changes, speaker changes, the start of an audio break, or the end of an audio break.

Recognition engine 212 may also generate a unique ID for each piece or segment of the rich media content. The information (extracted information, time data, and content segment ID) may be output in various forms that the rest of system 100 may use to match appropriate ads at the appropriate time when the content is accessed and played. For example, information extracted from the audio component of the rich media content may be in the form of keywords, the full text transcript, related concepts or topics, changes in topics, etc. Similarly, information extracted from the visual component of the rich media content may be output in the form of meta-data generated or culled from the content itself, and textual meta-data, text transcript, and/or keywords identified from either of the foregoing, may be output. All of the information output by recognition engine 212 may be stored in content database 208, which may be implemented as a hash table, index, database, or any other storage medium. This provides an index of information associated with the rich media content.

Correlation assistant 214 can be used to process correlation information provided by advertisers (such as from advertiser system 106), such as keywords, phrases or concepts, along with their ads and related information. Keywords may be words that can be used to match information in the content. The phrases may be any combination of words and other information, such as symbols, images, etc. The concepts may be a conceptual idea of something. For example, if a portion of rich media relates to Lebron James, this can be conceptualized to basketball, and advertisements related to basketball can be correlated to the rich media even if for some reason the term “basketball” is not identified by recognition engine 212. The related information can include URLs, presentations of ads, targeted content categories, etc. to be associated with the ad space or inventory that an advertiser has obtained. The advertiser can also specify anti-keywords, phrases, or concepts. An anti-keyword is a keyword or phrase that an advertiser chooses such that if that keyword or phrase is recognized in the rich media content, the advertiser's ad would not be shown, even if there is a keyword/phrase match.

Correlation assistant 214 can also be used to assist an advertiser in selecting keywords, such as by suggesting which keywords may be associated with an advertiser, and showing how popular a keyword is. Correlation assistant 214 may display similar keywords for an advertiser to choose from. This may give an advertiser more or even better keywords that may result in better matches.

Advertisers may also specify other associations for their ads. Such associations may include but are not limited to keyword/anti-keyword, phrase/anti-phrase, concept/anti-concept, and domain category/anti-category. A category may refer to sports, news, business, entertainment, etc.

The operation of correlation engine 202 will now be described. The function of correlation engine 202 is to select an advertisement that is suitably relevant to a portion, or time segment, of rich media content and to determine an appropriate time on the timeline for the content at which the advertisement should be started (or rotated in place of a prior advertisement). As shown in FIG. 2, correlation engine 202 receives as input the outputs of recognition engine 212 and correlation assistant 214, and may also include other inputs, as described in more detail below. Correlation engine 202 provides output to rendering formatter 204, such as in the form of the identities of a sequence of advertisements and the time alignment for each advertisement relative to the rich media content. As described in more detail in the incorporated '707 application, rendering formatter 204 then determines how the advertisement should be rendered relative to the rich media content, and rendering formatter 204 provides rendering preferences to ad server 206, which is configured to serve the advertisement(s)

Correlation engine 202 finds candidate segments of rich media content that may be relevant to an advertisement. This can be done by searching for the information about the content output by recognition engine 212 and stored in content database 208, to match the keywords, categories, and concepts associated with the ad, as output by correlation assistant 214 and stored in advertisement database 210.

For each candidate piece, or time segment, of rich media content associated with an ad, correlation engine 202 may determine candidate times where the content may be relevant to the ad. Correlation engine 202 may locate the times where the keywords and concepts match. For each candidate time, correlation engine 202 may create an “ad anchor” holding the score for the match. The score may be a linear combination of various factors. For each piece of content, correlation engine 202 may prune away the low scoring anchors. For example, a threshold may be used where anchors below the threshold are not considered. Each remaining anchor may be treated as a point on the timeline of the rich media content, or segmentation point, at which an advertisement can begin (either as a first advertisement, or as a replacement for a prior advertisement).

Correlation engine 202 may produce an initial segmentation of the content, based on one or more of the types of potential segmentation points described above. For example, initial segmentation can be based on points of detected topic transitions and/or speaker transitions, determined from the audio component of the content. It may also, or instead, be based on points of detected topic or scene change determined from the visual component of the content. It may also, or instead, be based on associated text data, such as meta-data that identifies the start and end times of a segment that may be treated as single topic or logical unit for purposes of ad placement. Correlation engine 202 may also produce initial segmentation on other bases, such as a fixed, minimum, maximum, or preferred time interval for ad placement.

As shown in FIG. 2, correlation engine 202 includes an alignment module 216. Alignment module 216 receives any initial segmentation points produced by correlation engine 202 and the candidate segmentation points associated with rich media content from content storage 208. Alignment module 216 also receives segmentation constraints from content storage 208 (or other source, as appropriate). The segmentation constraints can be, for example, maximum segment length, minimum segment length, or preferred segment length. Alignment module 216 then selects and outputs final segmentation points from among the candidate segmentation points, as described in more detail below.

Depending on the inputs that it receives, alignment module 216 may perform either or both of two functions. If alignment module 216 receives initial segmentation points, then for segments that satisfy a specified constraint, such as a maximum segment length, alignment module 216 selects from among the candidate segmentation points those that best align with the initial segmentation points, subject to the segmentation constraints. For segments that are, for example, too long to satisfy a maximum segment length constraint, or if no initial segmentation points are received, alignment module 216 selects from among the candidate segmentation points those that best split the long segments, or unsegmented content, into appropriate segments, subject to the segmentation constraints. Each of these functions is described in turn.

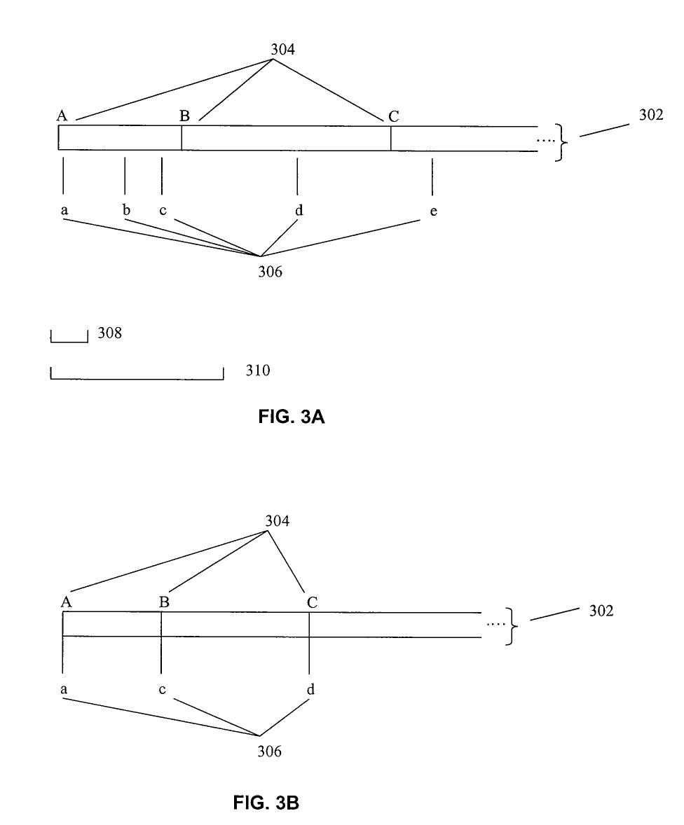

FIG. 3A illustrates the first function of alignment module 216. In this embodiment, alignment module 216 receives initial segmentation points 304 associated with rich media content 302. Alignment module 216 also receives candidate segmentation points 306 associated with rich media content 302. Alignment module 216 also receives one or more constraints. These constraints can be, for example, minimum and maximum segment lengths, 308 and 310, respectively.

When aligning the rich media content, alignment module 216 selects the candidate segmentation point that is temporally closest to each initial segmentation point while satisfying the one or more constraints, and uses that candidate segmentation point as a final segmentation point. In this example, 304A is the beginning of the content and 304B is the first initial segmentation point. The position of initial segmentation point 304B is used to determine the position of the temporally closest candidate segmentation point 306c. The temporal position of candidate segmentation point 306c relative to the most recently selected candidate segmentation point (i.e. the beginning of the content) lies within the constraints. That is, in this example, the distance from the beginning of the content to 306c is greater than the minimum segment length but less than the maximum segment length. As a result, candidate segmentation point 306c becomes a final segmentation point. Put another way, initial segmentation point 304B is adjusted, or aligned, to the position of candidate segmentation point 306c.

After aligning initial segmentation point 304B, alignment module 216 moves to the next initial segmentation point 304C for alignment. Alignment of segmentation point 304C is done in the same fashion as alignment of 304b. First, alignment module 216 locates the candidate segmentation point temporally closest to the segmentation point 304C. In this example, candidate segmentation point 306e is temporally closest to 304C. In this case, however, the position of candidate segmentation point 306e relative to the most recently selected candidate segmentation point (i.e. 306c) is not within the constraints. That is, the distance from 306c to 306e is greater than the maximum segmentation constraint. Therefore, instead of aligning segmentation point 304C with candidate segmentation point 306e, the next closest candidate segmentation point 306D is examined. The temporal position of candidate segmentation point 306d relative to 306c is within the constraints. That is, in this example, the distance from 306c to 306d is greater than the minimum segment length but less than the maximum segment length. As a result, segmentation point 304C is aligned to candidate segmentation point 306d.

Alignment module 216 continues to align the remaining initial segmentation points with candidate segmentation points until all initial segmentation points are aligned to a candidate segmentation point. Although, in this example, alignment module 216 aligns from left to right, i.e. from beginning to end of the content, alignment can be done in any order, such as end to beginning, starting from the middle, or even in random sequence.

FIG. 3B illustrates the resulting alignment after the first function of alignment module 216 has finished aligning segmentation points. The aligned segmentation points are thus output by alignment module 216, and correlation engine 202, for use by rendering formatter 204. This output can be in several forms including, but not limited to, a set of segmentation pairs, each pair containing an initial segmentation point and the candidate segmentation point with which it is aligned. The output could also be a set of segmentation points representing the chosen candidate segmentation points. This output is stored in content database 208 for use by rendering formatter 204.

Rendering formatter 204 determines how an advertisement should be rendered relative to a time portion of the content. Rendering formatter 204 may use the segmentation points output by alignment module 216 to render an advertisement during a specific portion of playback of the associated content. For example, an advertisement anchored at an initial segmentation point is rendered by rendering formatter 204 at the candidate segmentation point with which the initial point is aligned. As a result, advertisements are rendered in accordance with the output of alignment module 216.

In the example above, the constraints applied were minimum segment length and maximum segment length. However, other constraints can be applied. For example, a preferred segment length may be specified, such that the function yields segmentation points that meet the minimum and maximum segment lengths, but are also as close as possible to the preferred segment length. Another constraint can be that only candidate segmentation points associated with the video component of the rich media content are considered. Similarly, only candidate segmentation points associated with the audio component may be considered.

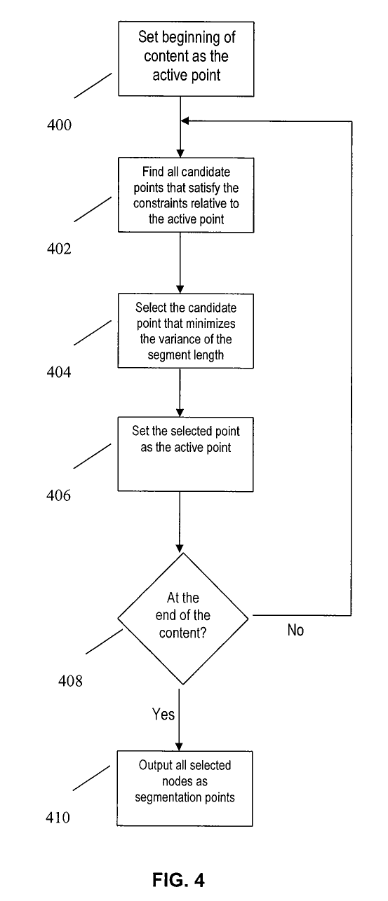

FIG. 4 is a flowchart illustrating the operation of the second function of alignment module 216, in which unsegmented content, or a segment that is too long, is split into shorter segments, subject to the segmentation constraints. Each shorter segment is aligned to begin at a candidate segmentation point. At 400, the beginning of the content is set as the active point. The engine then finds the candidate segmentation points that satisfy the constraints relative to the active point at 402. For example, if the constraints define minimum and maximum segment lengths, all candidate points within that range are found. Next, at 404, if multiple candidate points satisfy the constraints, further constraints such as, for example, minimizing the variance of segment length are used to select a candidate point. At 406, the selected point is set as the active point. If not at the end of the content, the method loops back to 402 with the current active point. The method keeps looping until the end of the content at 406. Once no more content is left to segment, all selected candidate points are provided as segmentation points.

This function of alignment module 216 can be implemented through dynamic programming. The following procedure is one example of a dynamic programming implementation:
0. Initialization
   Set segment IDs, 0 to segment length, 1 to the last video scene boundary, . . . , N to the first video scene boundary
   Set M=N
   Set active node to beginning of the input
1. Loop i=0 to M
1.1 Finds available path
   Find active node where length to the node is between minimum/maximum length. If several nodes are found, select the node which minimizes the variance.
1.2 Check terminate condition
   If node found and i==0 then exit. Output the segment boundaries on the path to the node.
1.3 Increment i by 1 and go to 1.1
2. Decrease M by 1.
   If M=0 then exit and no available boundaries are found.
   Go to 1.

Although a dynamic programming implementation is illustrated, various programming techniques may be used to split a segment into multiple smaller segments such as, for example, rules-based logic or recursion.

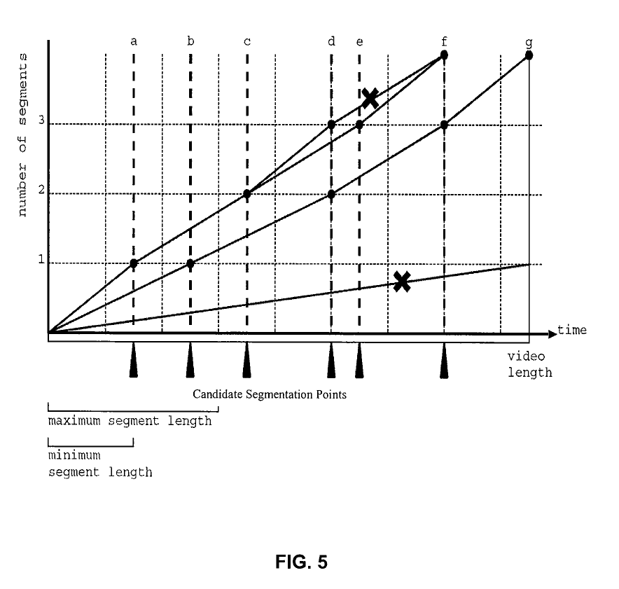

The operation of the second function of alignment module 216 is now described by reference to FIG. 5. In this example, the alignment module receives unsegmented rich media content. The alignment module also receives candidate segmentation points associated with the rich media content. The alignment module also receives one or more constraints. In this example, the constraints are minimum and maximum segment lengths.

In the first step of this function, the candidate segmentation point representing the beginning of the rich media content is set as active. Second, starting at the end of the rich media content and moving successively towards the beginning of the content, the constraints are applied to each candidate segmentation point relative to the active node. In FIG. 5, candidate segmentation point g does not fall within the maximum segment length relative to the active node (i.e. the beginning of the rich media content). Put another way, a segment from the beginning of the content to candidate segmentation point g would violate the maximum segment length constraint. Moving toward the beginning, candidate segmentation points f, e, d, and, c also do not satisfy the constraints. When candidate segmentation point b is reached, the constraints are satisfied. That is, the segment length from the current active node (i.e. the beginning of the rich media content) to candidate segmentation point b is greater than the minimum segment but less than the maximum segment length. Candidate segmentation point a also satisfies the constraints. Both candidate segmentation points a and b are selected.

Further constraints may be applied to narrow multiple selected nodes down to a single, active node. These constraints can be, for example, minimizing the variance of segment length or minimizing the number of segments.

In the example illustrated by FIG. 5, candidate segmentation point b is selected as the active node. The function returns to the first step and runs relative to the current active node. That is the constraints are applied to all nodes relative to candidate segmentation point b. During this iteration, candidate segmentation points c and d satisfy the maximum and minimum segment length constraints relative to the active node. Applying the further constraint of minimizing the variance of segment length, candidate segmentation point d is set as the active node.

The function runs in the manner described in the preceding paragraphs until it reaches the end of the rich media content. For the example illustrated in FIG. 5, the function selects candidate segmentation point f as an active node before reaching the end of the content.

Once the end of the rich media content is reached, all active nodes are set as segmentation points. For the example illustrated in FIG. 5, candidate segmentation points b, d, and f are set as segmentation points. The result is a segmented piece of rich media content, each segment beginning at a natural transition.

The following experiment verified the operation of the alignment module. The segmentation constraints provided to alignment module 216 were:
maximum segment length=30 sec
minimum segment length=10 sec
align to candidate segmentation point based on audio component of content (when applicable—not available unless audio has been extracted or provided)
align to candidate segmentation point based on visual component of content (when applicable)
do not segment when none of this information is available

To test the aligning function of alignment module 216, a routine named segmenter was run followed by a routine named matcher resulting in the following output:

### AdClassifier1:

[java] INPUT CONTENT:
. . .
[java] LENGTH=121000
. . .
[java] VIDEOSEGMENTS=Segmentation 0.00(0.70) 0.70(3.50) 4.20(6.50) . . . .
. . .
[java] MATCHING RESULT
[java]==CONCEPT SEGMENT==
[java] united_states
[java]==TIME==
[java] 28500|60100|88500|112900|121000

The first line of output indicates that rich media content is being input into alignment module 216. According to the second line of output, the length of this content is 121000 milliseconds. The initial segmentation points (not shown) are set at 0 ms, 30251 ms, 60501 ms, and 90751 ms. These segmentation points are equally divided to satisfy the minimum and maximum segment length constraints for content of length 121000 ms. The third line shows the candidate segmentation points input to alignment module 216. The pairs of numbers signify the beginning and length of a candidate segment. For example, the pair 0.70(3.50) represents a candidate video segment beginning 0.7 seconds after the beginning of the content and lasting for 3.5 seconds. After alignment module 216 runs, the last line of output indicates candidate segments beginning at 28500, 60100, 88500, and 112900 were selected as advertisement anchors. That is, the initial segmentation points were aligned with these candidate segmentation points.

1. A method comprising:
receiving a plurality of candidate segmentation points associated with a portion of rich media content;
selecting a subset of said candidate segmentation points that meet one or more segmentation constraints, said selected subset of segmentation points defining a plurality of temporal segments of the rich media content; and
providing said selected subset of segmentation points for association of a different one of a plurality of advertisements with each of the temporal segments.

2. The method of claim 1, wherein said candidate segmentation points are temporal points in the rich media content associated with events selected from the group consisting of scene changes, topic changes, speaker changes, the start of an audio break and the end of an audio break.

3. The method of claim 1, wherein said constraints include one or more of a minimum segment length, a maximum segment length and a preferred segment length.

4. The method of claim 1, wherein said constraints include one or more of minimizing the number of segments and minimizing the variance among segment lengths.

5. The method of claim 1, further comprising:
receiving a plurality of initial segmentation points associated with the portion of rich media content;
and wherein said selecting a subset of said candidate segmentation points includes selecting for each initial segmentation point a candidate segmentation point that is temporally closest to the initial segmentation point, consistent with said segmentation constraints.

6. A method comprising:
based on the subject matter of each of a plurality of portions of rich media content, correlating to each of said portions a different one of a plurality of advertisements;
selecting from each portion of rich media content a segmentation point based on a visual component of said portion, temporally adjacent segmentation points defining a segment of said content; and
providing said segmentation points for association of each of said correlated advertisements with the corresponding segment of content.

7. The method of claim 6, wherein said selecting includes selecting a segmentation point that corresponds to one of a scene change, a wipe, and a speaker change in said video component of said content.
